(19) United States
(12) Patent Application Publication
(10) Pub. No.: US 2025/0131432 A1
(43) Pub. Date: Apr. 24, 2025

(54) DEVICES, SYSTEMS, METHODS, AND NON-TRANSITORY COMPUTER-READABLE MEDIA FOR INDIVIDUAL IDENTITY AFFIRMATION

(71) Applicant: MASTERCARD INTERNATIONAL INCORPORATED, Purchase, NY (US)

(72) Inventor: Przemek Praszczalek, Williamsburg, VA (US)

(21) Appl. No.: 18/919,849

(22) Filed: Oct. 18, 2024

Related U.S. Application Data
(60) Provisional application No. 63/592,069, filed on Oct. 20, 2023.

(51) Int. Cl. G06Q 20/40

(52) U.S. Cl. CPC G06Q 20/4014; G06Q 20/4016

(57) ABSTRACT

Devices, methods, and non-transitory computer-readable media for performing an identity affirmation of an individual with two or more transaction communication networks.

### CROSS-REFERENCE TO RELATED APPLICATION

This application claims priority to, and the benefit of, U.S. Provisional Application No. 63/592,069, filed on Oct. 20, 2023, the entire contents of which is incorporated herein by reference.

### FIELD OF THE INVENTION

The present disclosure relates generally to secure user identification. More specifically, the present disclosure relates to devices, methods, and non-transitory computer-readable media with individual identity affirmation.

### SUMMARY

One embodiment of the present disclosure includes an identity server. The identity server includes a memory, a communication interface, and an electronic processor. The communication interface is configured to communicate with a partner device, a first transaction communication network, and a second transaction communication network that is separate and distinct from the first transaction communication network. The electronic processor is configured to perform an identity affirmation of an individual by communicating with a first entity over the first transaction communication network and communicating with a second entity over the second transaction communication network, and control the communication interface to output an identity affirmation message to the partner device based on the identity affirmation that is performed.

Another embodiment of the present disclosure includes a method. The method includes performing, with an electronic processor, an identity affirmation of an individual by communicating with a first entity over a first transaction communication network and communicating with a second entity over a second transaction communication network that is separate and distinct from the first transaction communication network. The method also includes outputting, with the electronic processor, an identity affirmation message to a partner device based on the identity affirmation that is performed.

Yet another embodiment of the present disclosure includes a non-transitory computer-readable medium with instructions that, when executed by an electronic processor, causes the electronic processor to perform a set of operations. The set of operations includes performing an identity affirmation of an individual by communicating with a first entity over a first transaction communication network and communicating with a second entity over a second transaction communication network that is separate and distinct from the first transaction communication network. The set of operations also includes controlling a communication interface to output an identity affirmation message to a partner device based on the identity affirmation that is performed.

### BRIEF DESCRIPTION OF THE FIGURES

FIG. 1 is a block diagram illustrating an example system for securely affirming an identity of an individual or an entity with two or more transaction communication networks, in accordance with various aspects of the present disclosure.

FIG. 2 is a flow diagram illustrating a comparative example.

FIG. 3 is a flow diagram illustrating an example of the system with a partner device interacting with the two or more transaction communication networks, in accordance with various aspects of the present disclosure.

FIG. 4 is a flow diagram illustrating an example of the system with a partner device interacting with the two or more transaction communication networks, in accordance with various aspects of the present disclosure.

FIG. 5 is a flow diagram illustrating an example of the system performing identity affirmation, in accordance with various aspects of the present disclosure.

FIG. 6 is a diagram illustrating an example flow of FIG. 5 when the partner device is owned by—for example—an insurance company, in accordance with various aspects of the present disclosure.

FIG. 7 is a diagram illustrating an open banking network example of FIG. 5, in accordance with various aspects of the present disclosure.

FIG. 8 is a diagram illustrating a payment processor debit network example of FIG. 5, in accordance with various aspects of the present disclosure.

FIG. 9 is a diagram illustrating an identity affirmation service example of FIG. 5, in accordance with various aspects of the present disclosure.

FIG. 10 is a diagram illustrating a verification result example of FIG. 5, in accordance with various aspects of the present disclosure.

FIG. 11 is a diagram illustrating differences between debit and credit network signals, in accordance with various aspects of the present disclosure.

FIG. 12 is a diagram illustrating use cases of an identity affirmation service, in accordance with various aspects of the present disclosure.

FIG. 13 is a diagram illustrating an example method of performing an identity affirmation of an individual, in accordance with various aspects of the present disclosure.

### DETAILED DESCRIPTION OF THE EMBODIMENTS

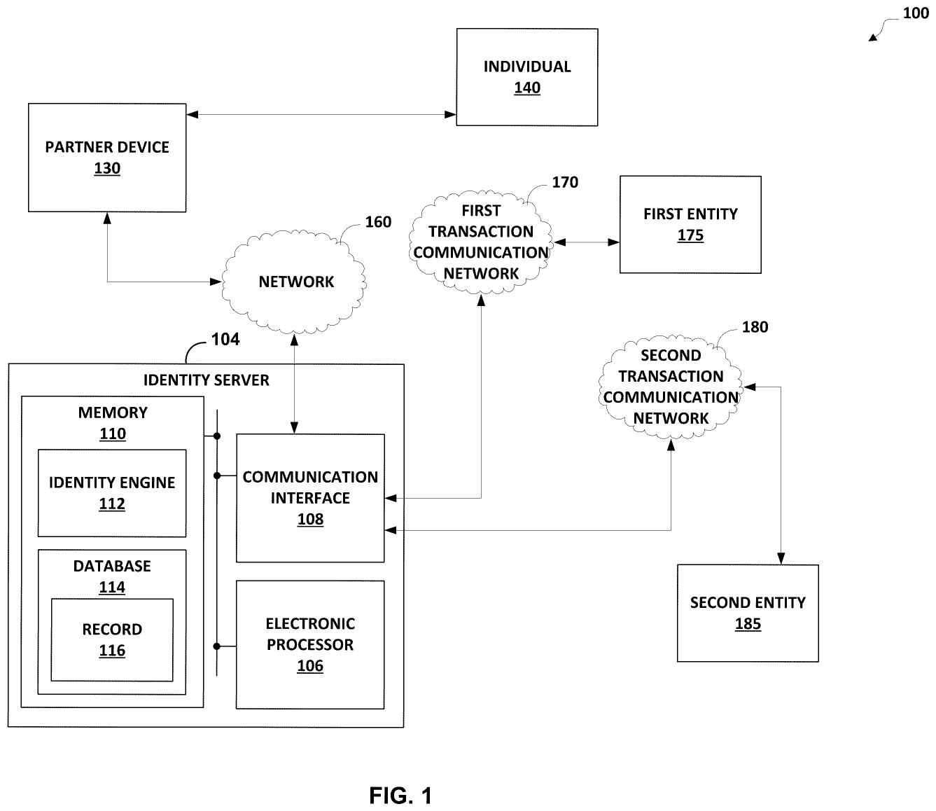

FIG. 1 is a block diagram illustrating an example system 100 for securely affirming an identity of an individual, entity, or a thing with two or more transaction networks, in accordance with various aspects of the present disclosure. In the example of FIG. 1, the system 100 includes an identity server 104, a partner device 130, an individual 140, a network 160, a first transaction communication network 170, and a second transaction communication network 180.

The identity server 104 may be owned by, or operated by or on behalf of, an administrator. The identity server 104 may also be implemented by one or more networked computer servers.

The identity server 104 includes an electronic processor 106, a communication interface 108, and a memory 110. The electronic processor 106 is communicatively coupled to the communication interface 108 and the memory 110. The electronic processor 106 is a microprocessor or another suitable processing device. The communication interface 108 may be implemented as one or both of a wired network interface and a wireless network interface. The memory 110 is one or more of volatile memory (e.g., RAM) and non-volatile memory (e.g., ROM, FLASH, magnetic media, optical media, et cetera). In some examples, the memory 110 is also a non-transitory computer-readable medium. Although shown within the identity server 104, memory 110 may be, at least in part, implemented as network storage that is external to the identity server 104 and accessed via the communication interface 108. For example, all or part of memory 110 may be stored on the “cloud.”

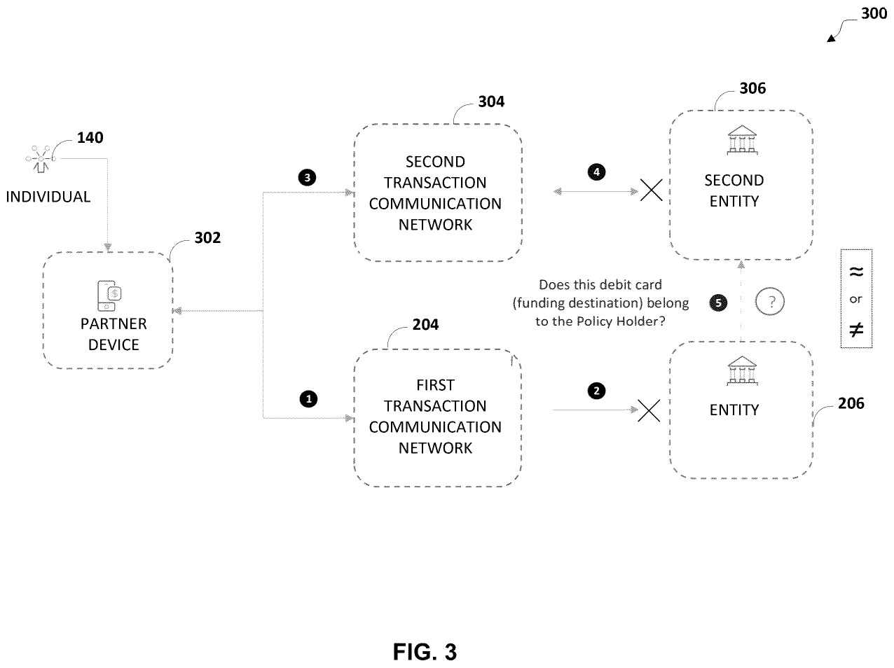

The identity engine 112 may be stored within a transitory or non-transitory portion of the memory 110. The identity engine 112 includes machine readable instructions that are executed by the electronic processor 106 to perform the functionality of the identity server 104 as described below with respect to FIGS. 3-12.

The memory 110 may include a database 114 for storing information about individuals. The database 114 may be an RDF database, i.e., employ the Resource Description Framework. Alternatively, the database 114 may be another suitable database with features similar to the features of the Resource Description Framework, and various non-SQL databases, knowledge graphs, etc. The database 114 may include a plurality of records. Each record may be associated with and contain personal information about one individual. For example, the personal information may include user-provided data, data insights, risk scores, account details, and identity data. Additionally, in the illustrated embodiment, record 116 may be associated with the individual 140, and other N records may be respectively associated with one of N other individuals (not expressly shown in FIG. 1).

The partner device 130 may also be implemented by one or more networked computer servers. The partner device 130 includes an electronic processor in communication with memory. The electronic processor is a microprocessor or another suitable processing device, the memory is one or more of volatile memory and non-volatile memory. The communication interface may be a wireless or wired network interface.

An application, which contains software instructions implemented by the electronic processor of partner device 130 to perform the functions of the partner device 130 (or other partner devices with different reference numbers) as described herein, is stored within a transitory or a non-transitory portion of the memory. The application may have a graphical user interface that facilitates interaction between the individual 140 and the partner device 130.

The partner device 130 may include or be in communication with a point-of-sale (POS) system, e.g., a mobile POS system (such as a mobile card reader), a web portal (Internet site), or a digital gateway, which can facilitate collection and processing of data from the individual 140. As discussed herein, the partner device 130 may use the mobile POS system to, among other things, read a partner-specific identification asset (not shown and considered to be part of the block “individual 140”) associated with the individual 140 to verify the identity of the individual 140. The partner-specific identification asset may be a credit card, debit card, a digital card from a digital wallet, or other suitable identification asset.

In some examples, the partner device 130 may communicate with the identity server 104 over the network 160 (for example, the identity server 104 may be connected to the network 160 with an Internet connection or other suitable communication connection). The network 160 may be a wireless network (e.g., a wireless personal area network), a local area network, or other suitable network. In other examples, the partner device 130 may directly communicate with the identity server 104.

In an embodiment, the memory of the partner device 130 may include a database and software. The database of the partner device 130 may include information about individual 140 and other individuals, as set forth herein. The software of the partner device 130 may facilitate interaction between the partner device 130 and individuals (e.g., the individual 140) and allow for the partner device 130 to track the interactions as described in greater detail below.

The identity server 104 may likewise communicate with partner devices other than the partner device 130. The term “partner”, as used herein, encompasses any other organizations engaging with individuals, including but not limited to businesses, non-governmental organizations, and other charitable institutions (including governmental organizations). The term “individual”, as used herein, encompasses a person (or household), an entity, or a thing that seeks to interact with an organization or other entity, including but not limited to seeking access to services (e.g., an individual seeking disbursement of insurance funds, an individual in a refugee camp, a person who receives support, etc.).

The identity server 104 may also communicate with entities over two or more transaction networks. For example, the identity server 104 may communicate with a first entity 175 over the first transaction communication network 170 and with a second entity 185 over the second transaction communication network 180. In some examples, the first transaction communication network 170 may be a payment processor debit card network, a payment processor credit card network, an interaction network, a value exchange network, a data exchange network, or other suitable network. In some examples, the second transaction communication network 180 may be an open banking network, an interaction network, a value exchange network, a data exchange network, or other suitable network.

In some examples, the first entity 175 and the second entity 185 may be the same entity. In other examples, the first entity 175 and the second entity 185 may be different entities. The term “entity”, as used herein, encompasses any other organizations engaging with individuals, including but not limited to banks and financial institutions. The workings of the identity server 104 and the partner device 130 will now be described in additional detail with FIGS. 3-12.

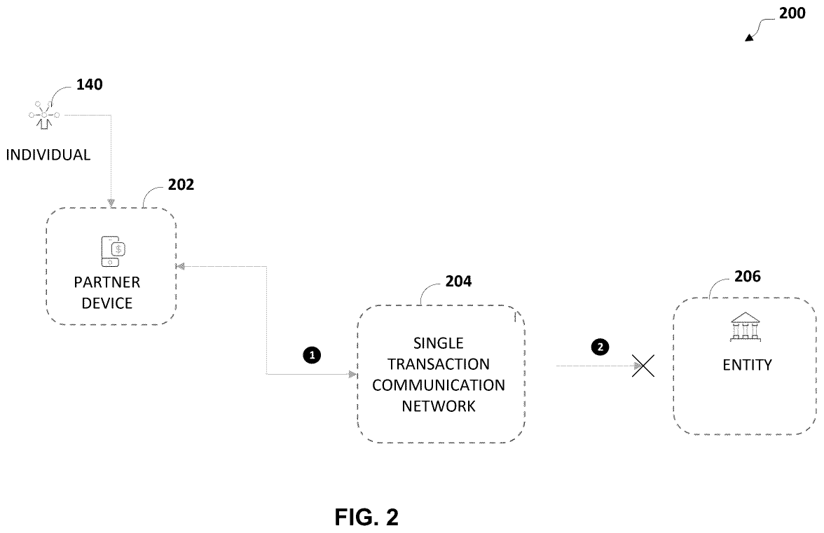

FIG. 2 is a flow diagram illustrating a comparative example 200. In the comparative example 200, a partner device 202 (e.g., a server or other electronic device/platform owned and/or administratively controlled by an insurance provider) interacts with a first transaction communication network 204 (e.g., a payment processor debit network) to receive a disbursement of funds when the individual 140 has a claim to the disbursement of funds (e.g., the individual 140 is a policyholder owed money by the insurance provider).

In one example, the individual 140 may provide payment account information (e.g., debit card credentials) to the partner device 202. The partner device 202 may then interact with the first transaction communication network 204 to provide the disbursement of funds using the debit credentials of the individual 140 (operation 1). The first transaction communication network 204 routes the disbursement of funds to an entity 206 (e.g., a bank or financial institution, digital asset custodian, crypto wallet, digital wallet, etc.) associated with the payment account information of the individual 140 (operation 2).

However, in the above example of FIG. 2, the partner device 202 cannot proactively confirm that the payment account information is legitimate and actually belongs to the individual 140 or to an individual that has a rightful claim to the disbursement of funds. Therefore, the partner device 202 cannot transfer the funds until additional information is provided by the individual 140.

FIG. 3 is a flow diagram illustrating an example 300 of the system 100 with a partner device 302 interacting with the two or more transaction communication networks, in accordance with various aspects of the present disclosure. Specifically, the partner device 302 interacts with the first transaction communication network 204 (e.g., the payment processor debit network) and a second transaction communication network 304 (e.g., an open banking network or a credit card network).

Like FIG. 2, the individual 140 may provide payment account information (e.g., debit card credentials) to the partner device 302. However, unlike FIG. 2, the payment account information may also include additional information (e.g., credit card credentials or open banking network credentials for accessing the second transaction communication network 304).

In the example 300, when the second transaction communication network 304 is an open banking network 304, the partner device 302 may provide the disbursement of funds to the open banking network 304 using the open banking network credentials (operation 3). The open banking network 304 routes the disbursement of funds to a second entity 306 (e.g., a bank or financial institution) associated with the open banking network credentials of the individual 140 (operation 4).

However, in the above example of FIG. 3, the partner device 302 cannot proactively confirm that the payment account information is legitimate and actually belongs to the individual 140 or to an individual that has a rightful claim to the disbursement of funds. Therefore, the partner device 302 cannot or may not be able to transfer the funds (or may have to increase friction for user) until additional information is provided by the individual 140 or until the partner device 302 is able to perform identify affirmation using the first transaction communication network 204 in combination with the open banking network 304 as described in greater detail below.

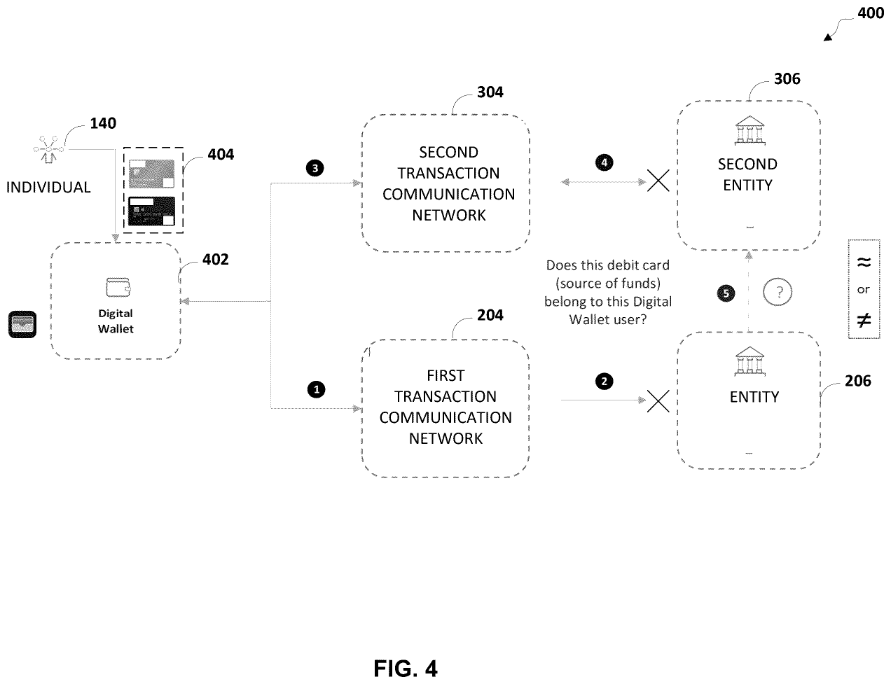

FIG. 4 is a flow diagram illustrating an example 400 of the system 100 with a partner device 402 interacting with the two or more transaction communication networks, in accordance with various aspects of the present disclosure. The example 400 is similar to the example 300. However, in the example 400, the individual 140 is interacting with the partner device 402 (e.g., a digital wallet) instead of the partner device 302 and the individual 140 has a plurality of debit cards 404. Like the example 300, in the example 400, the partner device 402 cannot transfer the funds until additional information is provided by the individual 140 or until the partner device 402 is able to perform identify affirmation using the first transaction communication network 204 (e.g., the payment processor debit network) in combination with the second transaction communication network 304 as described in greater detail below.

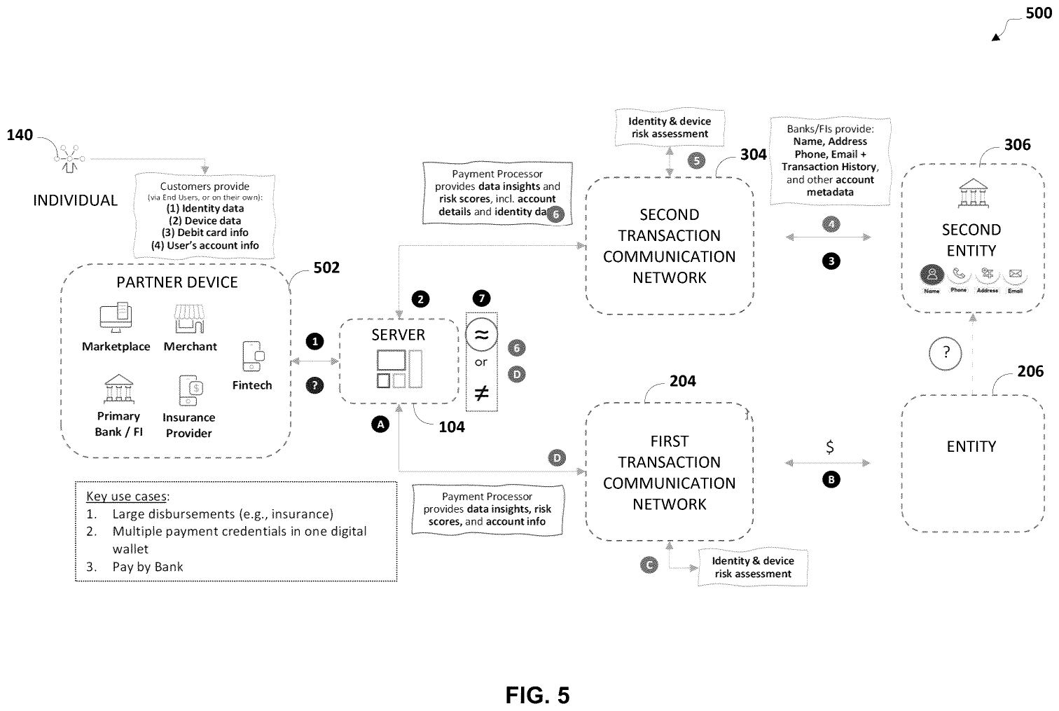

FIG. 5 is a flow diagram illustrating an example 500 of the system 100 performing identity affirmation, in accordance with various aspects of the present disclosure. FIG. 5 is described with respect to FIGS. 1-3. In FIG. 5, the example 500 includes the individual 140, a partner device 502, an identity server 104, the first transaction communication network 204 (or any value exchange network), the entity 206, the second transaction communication network 304, and the second entity 306.

As illustrated in FIG. 5, the individual 140 may provide payment account information (e.g., 1) identity data, 2) device data, 3) debit card credentials, and 4) user account information) or any other personal/business/entity data to the partner device 502. The partner device 502 (e.g., a server or other electronic device) is owned and/or administratively controlled by an insurance provider, a marketplace, a merchant, a financial technology entity, a bank, or other suitable entity.

In the example 500, the partner device 502 may request identity affirmation from the identity server 104 (operation 1). The identity server 104 may then send a test deposit to the first transaction communication network 204 (operation A). The first transaction communication network 204 routes the test deposit to the entity 206 (operation B). The first transaction communication network 204 performs identity and device risk assessment based on the test deposit (operation C) and provides data insights, risk scores, and account information to the identity server 104 (operation D).

Additionally, the identity server 104 also queries the second transaction communication network 304 for the name, address, phone number, email address, transaction history, and/or other account identity metadata from the second entity 306 (operation 2). The second transaction communication network 304 relays the query to the second entity 306 (operation 3) and then relays the response back to the identity server 104 (operation 4). The second transaction communication network 304 then performs an identity and device risk assessment based on the response from the second entity 306 (operation 5). The second transaction communication network 304 provides data insights, risk scores, account details, and identity data to the identity server 104 (operation 6).

Upon receiving the data insights, the risk scores, and the account information of the first account from the first transaction communication network 204 and the data insights, the risk scores, the account details, and the identity data of the second account from the second transaction communication network 304, the identity server 104 may determine whether the payment account information is owned by the individual 140 based on the data insights, the risk scores, and the account information regarding the first account and the data insights, the risk scores, the account details, and the identity data regarding the second account. In some examples, the identity server 104 may determine that the payment account information is owned by the individual 140 when some or all of account information (e.g., name, address, email address, phone number, and/or other suitable account information from bank records) of a first account matches corresponding account information of a second account.

Upon determining that the payment account information is owned by the individual 140, the identity server 104 may output an identity affirmation message or other control signal (e.g., a deposit approval control signal) to the partner device 502. Upon confirming that the payment account information is not owned by the individual 140, the identity server 104 may output a denial control signal (e.g., a deposit disapproval control signal) (or request additional metadata, or introduce a user challenge) to the individual 140 via the partner device 502.

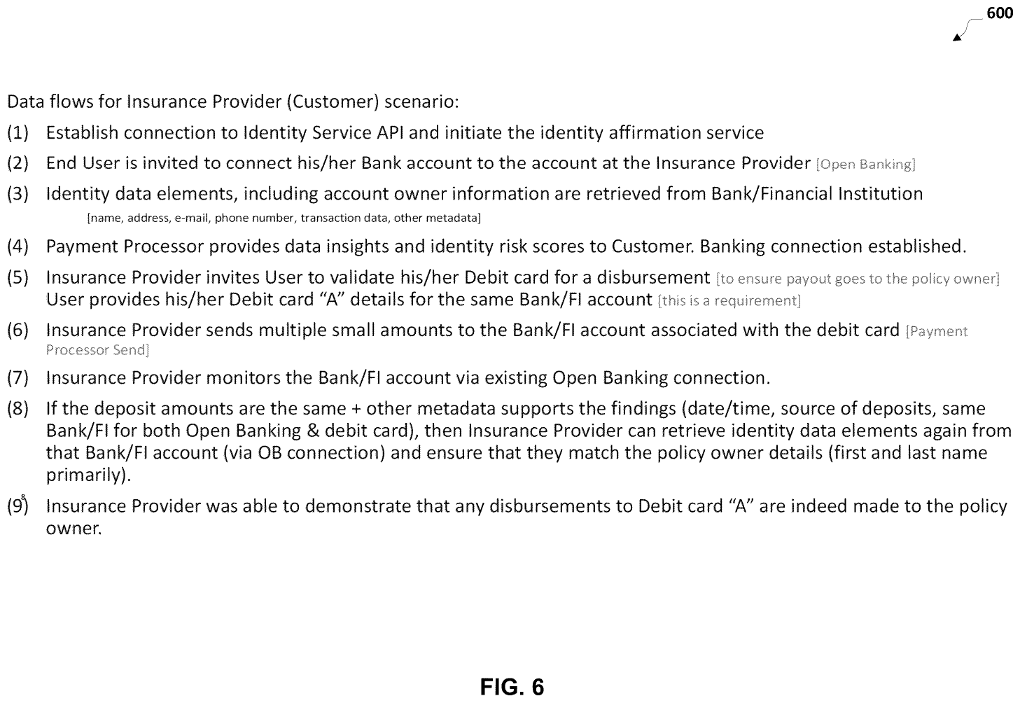

FIG. 6 is a diagram illustrating an example flow 600 of FIG. 5 when the partner device 502 is owned by an insurance company, in accordance with various aspects of the present disclosure. In the example flow 600, the partner device 502 establishes a connection to an identity service API provided by the identity server 104 and initiates the identity affirmation service (operation 1).

In the example flow 600, the partner device 502 invites the individual 140 (e.g., sending an electronic communication to the individual via an electronic device) to connect a bank account to an account managed by the partner device 502 (operation 2). In some examples, the bank account connection is an open banking network connection.

In the example flow 600, the identity server 104 retrieves identity elements including account owner information from one or more banks or financial institutions. (operation 3). The information retrieved may include name, address, email, phone number, transaction data, and other metadata.

In the example flow 600, the first transaction communication network 204 provides insights and identity risk scores to the partner device 502 and a banking connection is established (operation 4).

In the example flow 600, the partner device 502 invites the individual 140 to validate the debit card provided for disbursement to ensure disbursement goes to the policy owner (operation 5a). The individual 140 provides the debit card for the same bank or financial institution account used with the open banking network (operation 5b).

In the example flow 600, the partner device 502 sends multiple small amount deposits to the bank or financial institution account associated with the debit card (operation 6)

In the example flow 600, the partner device 502 monitors the bank or financial institution account via the existing open banking network connection (operation 7).

When the deposit amounts are the same and other metadata supports the findings (e.g., date, time, source of deposits, same bank or financial institution account for open banking and debit card), then the partner device 502 (via the identity server 104) may retrieve identity data elements again from that bank or financial institution account (e.g., via the open banking connection) and ensure that the retrieved identity elements match the policy owner details (e.g., first and last name) (operation 8).

The partner device 502 may then disburse the insurance funds because the partner device 502 was able to demonstrate that the test deposits made to the debit card of the individual 140 were made to the policy owner (operation 9).

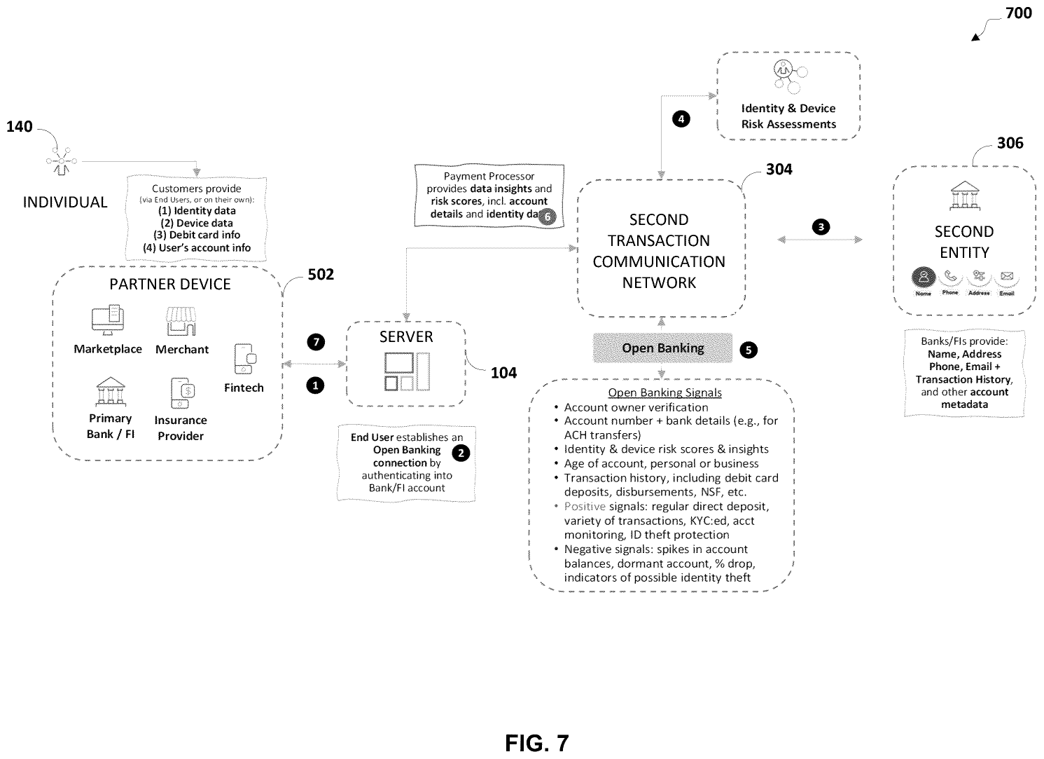

FIG. 7 is a diagram illustrating an open banking network example 700 of FIG. 5, in accordance with various aspects of the present disclosure. As illustrated in FIG. 7, the opening bank signals provided to the identity server 104 includes 1) account owner verification, 2) account number and bank details (e.g., for ACH transfers), 3) identity and device risk scores and insights, 4) age of account, personal or business, 5) transaction history including debit card deposits, disbursements, non-sufficient funds (NSF), etc., 6) positive signal, and 7) negative signals. The positive signals may include some or all of: regular direct deposit, variety of transactions, know your customer confirmation, account monitoring, and identity theft protection. The negative signals may include spikes in account balances, dormant account, percentage drop, indicators of possible identity theft.

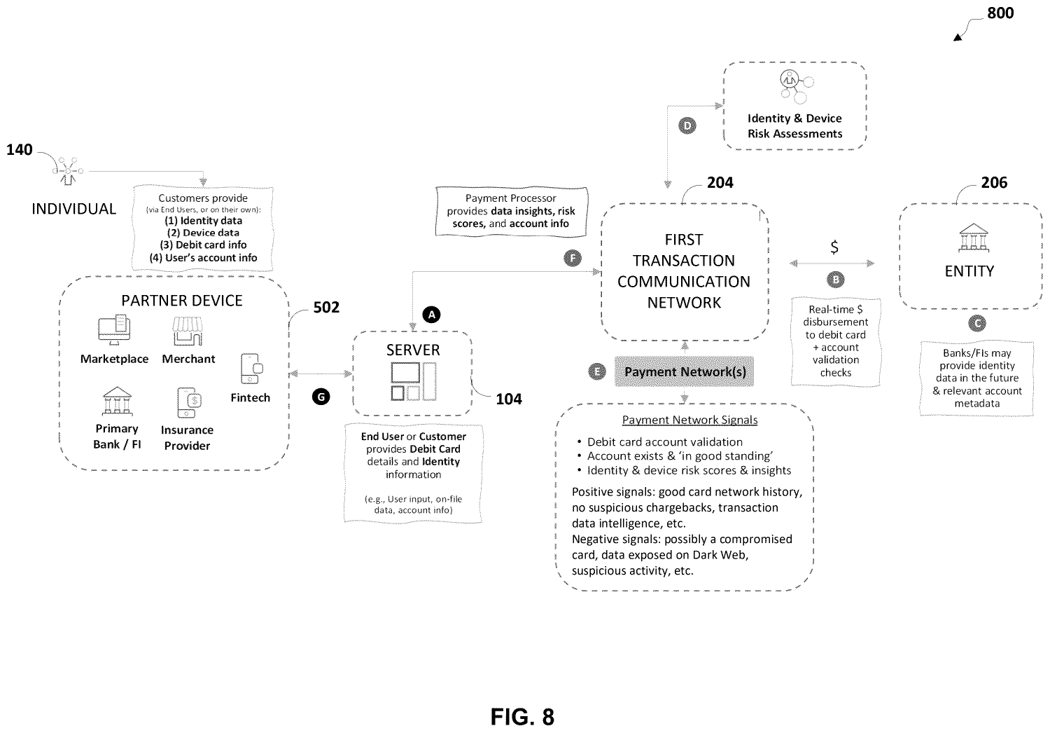

FIG. 8 is a diagram illustrating a payment processor debit network example 800 of FIG. 5, in accordance with various aspects of the present disclosure. As illustrated in FIG. 8, the payment network signals provided to the identity server 104 includes 1) debit card account validation, 2) account exists and “in good standing,” and 3) identity and device risk scores and insights.

In some examples, positive payment network signals may include card network history, no suspicious chargebacks, transaction data intelligence, or other suitable positive payment network signal. Additionally, in some examples, negative payment network signals may include a signal indicating a possibly compromised card, data exposed on Dark Web, suspicious activity, or other suitable negative payment network signal.

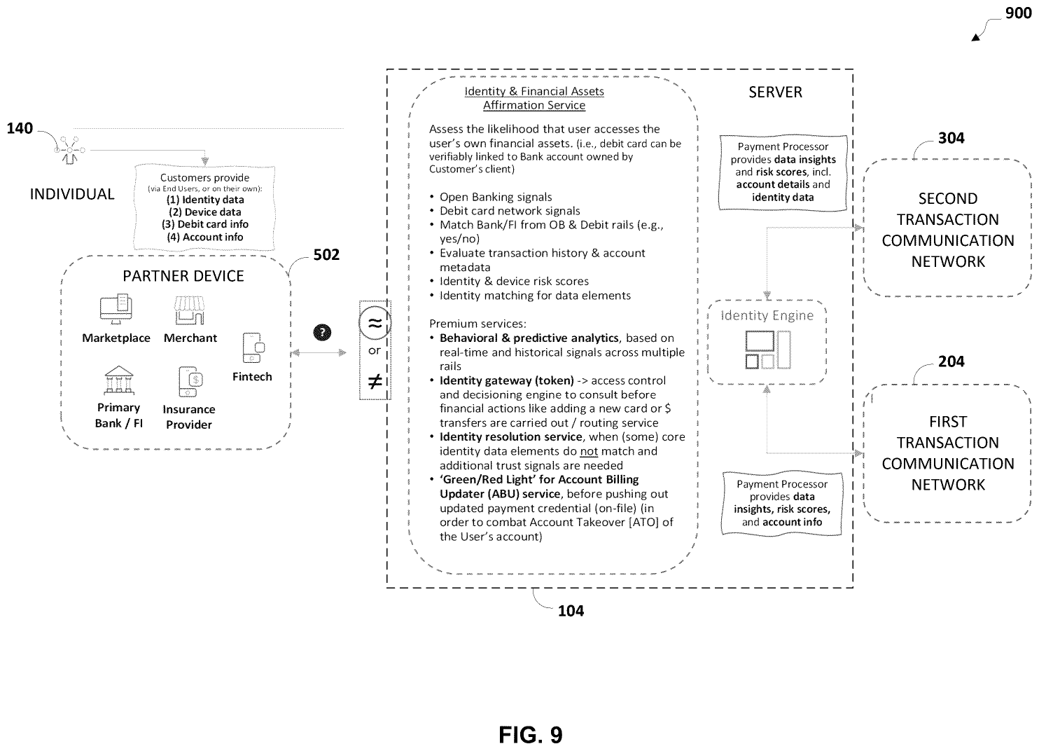

FIG. 9 is a diagram illustrating an identity affirmation service example 900 of FIG. 5, in accordance with various aspects of the present disclosure. As illustrated in FIG. 9, the identity affirmation service example 900 provided by the identity server 104 assesses the likelihood that the individual 140 accesses the individual's own financial assets (i.e., the debit card may be verifiably linked to a bank account administrated by a partner device).

The identity affirmation service example 900 uses open banking signals and debit card network signals (e.g., as described above in FIGS. 7 and 8) to match bank or financial institution accounts. The identity affirmation service example 900 also uses open banking signals and debit card network signals to evaluate transaction history and account metadata. The identity affirmation service example 900 may also use identity and device risk scores and identity matching for data elements.

In some examples, the identity affirmation service example 900 may provide the following premium services: 1) behavioral and predictive analytics, 2) identity gateway (token), 3) identity resolution service, and/or 4) “Green/Red light” for Account Billing Updater (ABU) service. The behavioral and predictive analytics is based on real-time and historical signals across multiple transaction networks. The identity gateway (token) is an access control and decisioning engine to consult before financial actions like adding a new card or money transfers are carried out/routing service is performed. The identity resolution service may be used to resolve when core identity data elements do not match, and additional trust signals are needed. The “Green/Red light” for Account Billing Updater (ABU) service may be performed before pushing out updated payment credential (to be on-file) in order to combat account takeover (ATO) of the account of the individual 140.

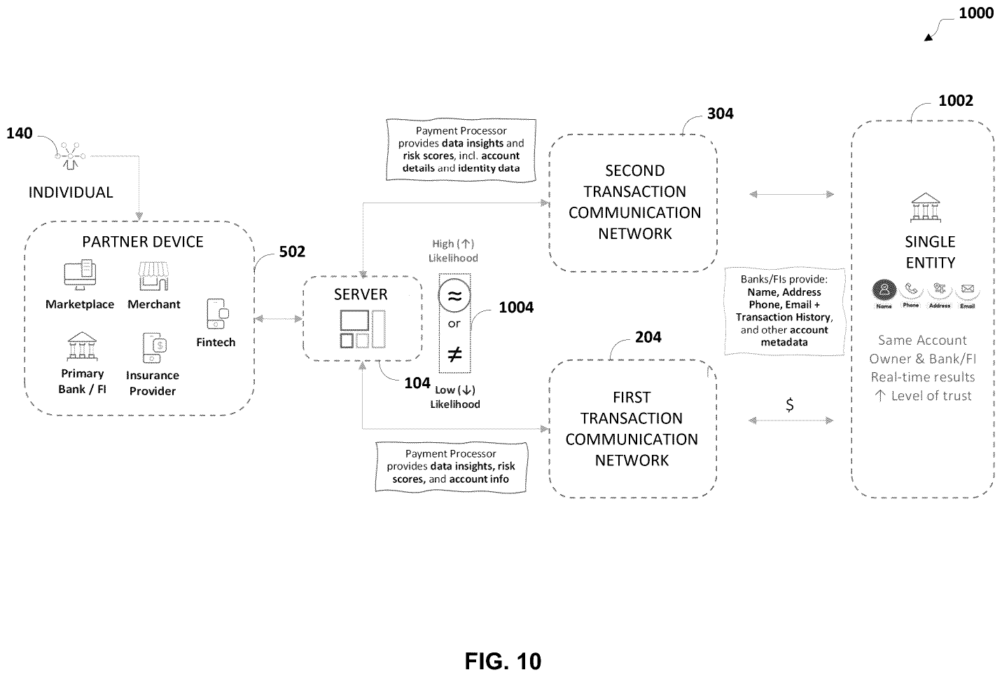

FIG. 10 is a diagram illustrating a verification result example 1000 of FIG. 5, in accordance with various aspects of the present disclosure. As illustrated in FIG. 10, the bank or financial institution account of the individual 140 is located at a single entity 1002 and is accessible via the first transaction communication network 204 and the second transaction communication network 304. Additionally, as illustrated in FIG. 10, the identity server 104 may output a verification result 1004 to the partner device 502. The verification result 1004 may indicate a high likelihood or a low likelihood the individual 140 has ownership of the account at the single entity 1002.

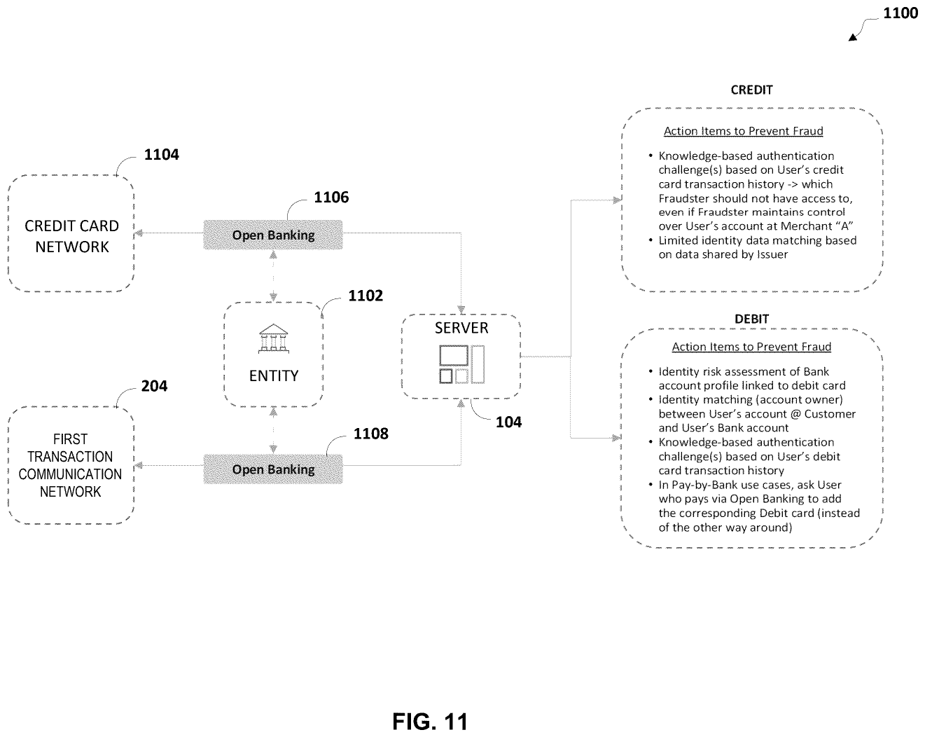

FIG. 11 is a diagram illustrating differences 1100 between debit and credit network signals, in accordance with various aspects of the present disclosure. In the example of FIG. 11, an entity 1102 accesses a credit card network 1104 through a first open banking network 1106 and the first transaction communication network 204 through a second open banking network 1108. The entity 1102 may query the identity server 104 to access credit network signals and debit network signals, respectively.

In some examples, the credit network signals may include knowledge-based authentication challenge(s) based on credit card transaction history, which a nefarious actor should not have access to even if the nefarious actor maintains control over the account at the entity 1102. In some examples, the credit network signals may also include limited identity data matching based on data shared by the issuer of the credit card.

In some examples, the debit network signals may include identity risk assessment of bank account profile linked to debit card. In some examples, the debit network signals may include identity matching (account owner) between account at partner device and bank or financial institution account. In some examples, the debit network signals may include knowledge-based authentication challenge(s) based on debit card transaction history. In some examples, the debit network signals may include pay-by-bank use cases, asking the individual 140 who pays via open banking to add corresponding debit card (instead of the other way around).

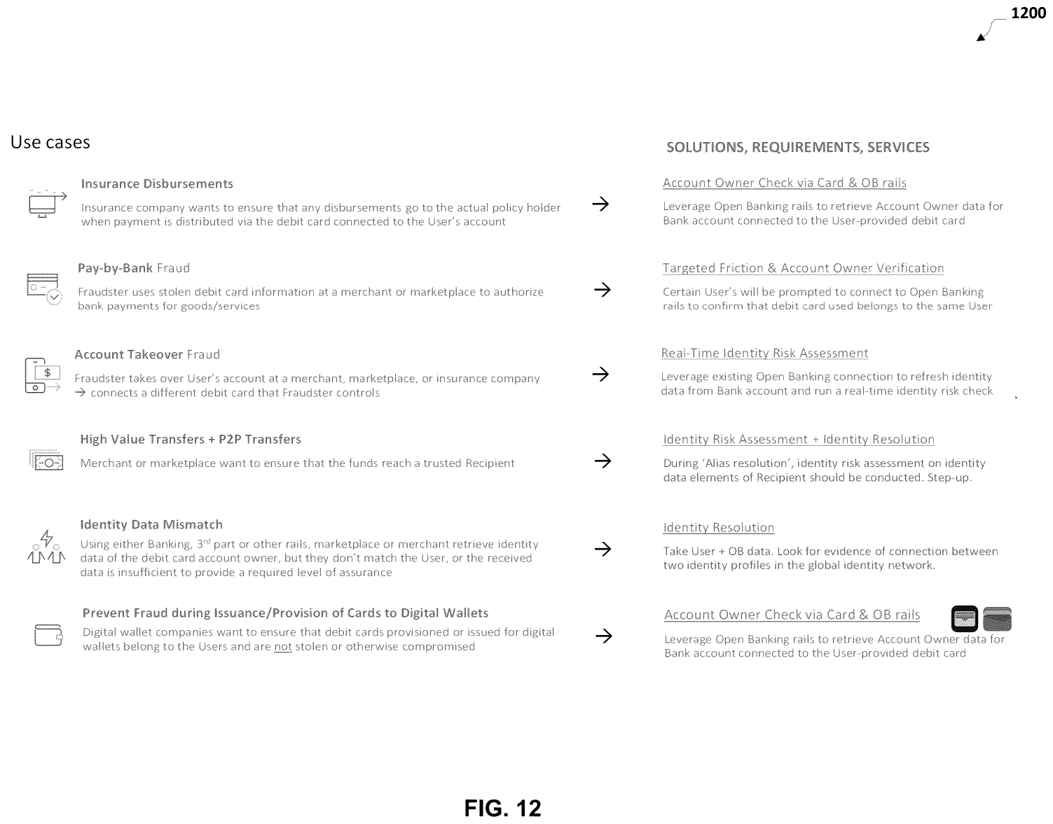

FIG. 12 is a diagram illustrating use cases 1200 of an identity affirmation service, in accordance with various aspects of the present disclosure. The use cases 1200 include 1) insurance disbursements, 2) pay-by-bank fraud, 3) account takeover fraud, 4) high value transfers and person-to-person (P2P) transfers, 5) identity data mismatch, and 6) prevent fraud during issuance/provision of cards to digital wallets.

For insurance disbursement, an insurance company wants to ensure that any disbursements go to the actual policy holder when payment is distributed via the debit card connected to the user's account. In this case, an account owner check may be performed via card network and open banking network. For example, open banking network may be leveraged to retrieve account owner data for bank account connected to the user-provided debit card.

For pay-by-bank fraud, a nefarious actor uses stolen debit card information at a merchant or marketplace to authorize bank payments for goods/services. In this case, targeted friction and account owner verification may be used to prevent or stop the fraud. For example, certain users may be prompted to connect to open banking network to confirm debit card used belongs to same user.

For account takeover fraud, a nefarious actor takes over a user's account at a merchant, marketplace, or insurance company and connects a different debit card that is under the control of the nefarious actor. In this case, a real-time identity risk assessment may be performed. For example, open banking may be leveraged to refresh identity data from bank account and run a real-time identity risk check.

For high value and P2P transfers, a merchant or marketplace may want to ensure that funds reach a trusted recipient. In this case, an identity risk assessment and identity resolution may be performed. For example, during an “alias resolution,” identity risk assessment on identity data elements of recipient may be conducted.

For identity data mismatch, using banking, third-party or other networks, marketplace or merchant may retrieve identity data of the debit card account owner that does not match the user, or the retrieved data is insufficient to provide a required level of assurance. In this case, an identity resolution may be performed. For example, using user provided data and open banking data, and look for evidence of connection between two identity profiles in the global identity network.

For prevent fraud during issuance/provision of cards to digital wallets, digital wallet companies want to ensure that debit cards provisioned or issued for digital wallets belong to the users and are not stolen or otherwise compromised. In this case, an account owner check may be performed via card network and open banking network. For example, open banking network may be leveraged to retrieve account owner data for bank account connected to the user-provided debit card.

Data enrichment of existing access tokens for Open Banking Network (which will include additional signals, risk scores, real-time metadata, and creation of a separate multi-rail access token at the identity engine level—which would house real-time data signals from multiple rails/domains (transaction, interaction, value exchange, and data exchange networks.”

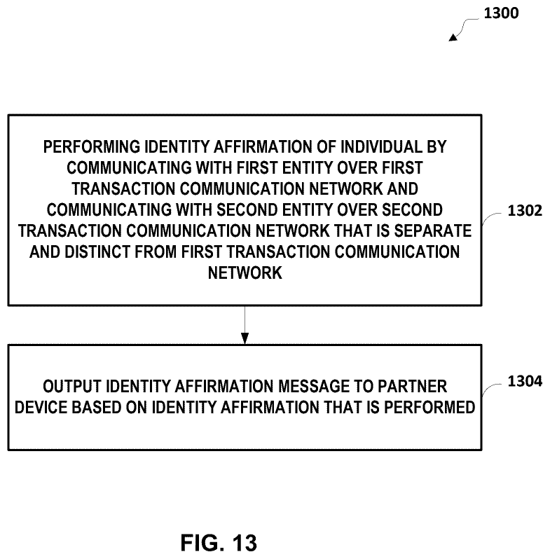

FIG. 13 is a diagram illustrating an example method 1300 of performing an identity affirmation of an individual, in accordance with various aspects of the present disclosure. The method 1300 includes performing, with an electronic processor, an identity affirmation of an individual by communicating with a first entity over a first transaction communication network and communicating with a second entity over a second transaction communication network that is separate and distinct from the first transaction communication network (at block 1302). The method 1300 also includes outputting, with the electronic processor, an identity affirmation message to a partner device based on the identity affirmation that is performed (at block 1304). In some examples, the identity affirmation that is performed includes assessing trust signals and risk signals that are either communicated from the first entity and/or the second entity or derived from communications with the first entity and/or the second entity.

In some examples, performing the identity affirmation of the individual may further include receiving payment account information of the individual, sending an identity test of a first account at the first entity via the first transaction communication network, the identity test based at least in part on the payment account information of the individual, receiving first data insights, first risk scores, and account information regarding the first account based on the identity test that is sent, querying the second transaction communication network for account identity metadata of a second account at the second entity, the query based on the payment account information of the individual, receiving second data insights, second risk scores, account details, and identity data regarding the second account from the second transaction communication network, and determining whether the payment account information is owned by the individual based on the first data insights, the first risk scores, and the account information regarding the first account in addition to the second data insights, the second risk scores, the account details, and the identity data regarding the second account.

In some examples, the payment account information may include some or all of identity data, device data, debit card credentials, and user account information. In some examples, the identity test is a test deposit to the first account. In some examples, the account identity information includes some or all of name, address, phone number, email address, transaction history of the second account.

In some examples, outputting the identity affirmation message to the partner device based on the identity affirmation that is performed further includes outputting a deposit approval control signal to the partner device in response to determining that the payment account information is owned by the individual. In other examples, outputting the identity affirmation message to the partner device based on the identity affirmation that is performed further includes outputting a deposit disapproval control signal to the partner device in response to determining that the payment account information is not owned by the individual.

The following examples are enumerated examples of the devices, methods, and non-transitory computer-readable media that perform identity affirmation of an individual. Example 1: an identity server comprising: a memory, a communication interface configured to communicate with a partner device, a first transaction communication network, and a second transaction communication network that is separate and distinct from the first transaction communication network, and an electronic processor that is configured to perform an identity affirmation of an individual by communicating with a first entity over the first transaction communication network and communicating with a second entity over the second transaction communication network, and control the communication interface to output an identity affirmation message to the partner device based on the identity affirmation that is performed.

Example 2: the identity server of Example 1, wherein, to perform the identity affirmation of the individual, the electronic processor is configured to: control the communication interface to receive payment account information of the individual, responsive to receiving the payment account information of the individual, control the communication interface to send an identity test of a first account at the first entity via the first transaction communication network, the identity test based at least in part on the payment account information of the individual, control the communication interface receive first data insights, first risk scores, and account information regarding the first account based on the identity test that is sent, responsive to receiving the payment account information of the individual, control the communication interface to query the second transaction communication network for account identity metadata of a second account at the second entity, the query based on the payment account information of the individual, control the communication interface to receive second data insights, second risk scores, account details, and identity data regarding the second account from the second transaction communication network, and determine whether the payment account information is owned by the individual based on the first data insights, the first risk scores, and the account information regarding the first account in addition to the second data insights, the second risk scores, the account details, and the identity data regarding the second account.

Example 3: the identity server of Example 2, wherein the payment account information includes some or all of identity data, device data, debit card credentials, and user account information.

Example 4: the identity server of Examples 2 or 3, wherein the identity test is a test deposit to the first account.

Example 5: the identity server of any of Examples 2-4, wherein the account identity information includes some or all of name, address, phone number, email address, transaction history of the second account.

Example 6: the identity server of any of Examples 2-5, wherein, to output the identity affirmation message to the partner device based on the identity affirmation that is performed, the electronic processor is further configured to responsive to determining that the payment account information is owned by the individual, control the communication interface to output a deposit approval control signal to the partner device.

Example 7: the identity server of any of Examples 2-6, wherein, to output the identity affirmation message to the partner device based on the identity affirmation that is performed, the electronic processor is further configured to responsive to determining that the payment account information is not owned by the individual, control the communication interface to output a deposit disapproval control signal to the partner device.

Example 8: a method comprising: performing, with an electronic processor, an identity affirmation of an individual by communicating with a first entity over a first transaction communication network and communicating with a second entity over a second transaction communication network that is separate and distinct from the first transaction communication network; and outputting, with the electronic processor, an identity affirmation message to a partner device based on the identity affirmation that is performed.

Example 9: the method of Example 8, wherein performing the identity affirmation of the individual includes receiving payment account information of the individual, sending an identity test of a first account at the first entity via the first transaction communication network, the identity test based at least in part on the payment account information of the individual, receiving first data insights, first risk scores, and account information regarding the first account based on the identity test that is sent, querying the second transaction communication network for account identity metadata of a second account at the second entity, the query based on the payment account information of the individual, receiving second data insights, second risk scores, account details, and identity data regarding the second account from the second transaction communication network, and determining whether the payment account information is owned by the individual based on the first data insights, the first risk scores, and the account information regarding the first account in addition to the second data insights, the second risk scores, the account details, and the identity data regarding the second account.

Example 10: the method of Example 9, wherein the payment account information includes some or all of identity data, device data, debit card credentials, and user account information.

Example 11: the method of Examples 9 or 10, wherein the identity test is a test deposit to the first account.

Example 12: the method of any of Examples 9-11, wherein the account identity information includes some or all of name, address, phone number, email address, transaction history of the second account.

Example 13: the method of any of Examples 9-12, wherein outputting the identity affirmation message to the partner device based on the identity affirmation that is performed further includes outputting a deposit approval control signal to the partner device in response to determining that the payment account information is owned by the individual.

Example 14: the method of any of Examples 9-13, wherein outputting the identity affirmation message to the partner device based on the identity affirmation that is performed further includes outputting a deposit disapproval control signal to the partner device in response to determining that the payment account information is not owned by the individual.

Example 15: a non-transitory computer-readable medium comprising instructions that, when executed by an electronic processor, causes the electronic processor to perform a set of operations comprising: performing an identity affirmation of an individual by communicating with a first entity over a first transaction communication network and communicating with a second entity over a second transaction communication network that is separate and distinct from the first transaction communication network; and controlling a communication interface to output an identity affirmation message to a partner device based on the identity affirmation that is performed.

Example 16: the non-transitory computer-readable medium of Example 15, wherein performing the identity affirmation includes controlling the communication interface to receive payment account information of the individual; controlling the communication interface to send an identity test of a first account at the first entity via the first transaction communication network, the identity test based at least in part on the payment account information of the individual; controlling the communication interface to receive first data insights, first risk scores, and account information regarding the first account based on the identity test that is sent; controlling the communication interface to query the second transaction communication network for account identity metadata of a second account at the second entity, the query based on the payment account information of the individual; controlling the communication interface to receive second data insights, second risk scores, account details, and identity data regarding the second account from the second transaction communication network; and determining whether the payment account information is owned by the individual based on the first data insights, the first risk scores, and the account information regarding the first account in addition to the second data insights, the second risk scores, the account details, and the identity data regarding the second account.

Example 17: the non-transitory computer-readable medium of Example 16, wherein the payment account information includes some or all of identity data, device data, debit card credentials, and user account information.

Example 18: the non-transitory computer-readable medium of Examples 16 or 17, wherein the account identity information includes some or all of name, address, phone number, email address, transaction history of the second account.

Example 19: the non-transitory computer-readable medium of any of Examples 16-18, wherein controlling the communication interface to output the identity affirmation message to the partner device based on the identity affirmation that is performed further includes controlling the communication interface to output a deposit approval control signal to the partner device in response to determining that the payment account information is owned by the individual.

Example 20: the non-transitory computer-readable medium of any of Examples 16-19, wherein controlling the communication interface to output the identity affirmation message to the partner device based on the identity affirmation that is performed further includes controlling the communication interface to output a deposit disapproval control signal to the partner device in response to determining that the payment account information is not owned by the individual.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

Additionally, operations (such as processes, decisions, inputs, outputs, actions, messages, interactions, events, and/or any other operations) shown in the flowcharts and/or message sequence charts may be illustrated once each and in a particular order in the drawings. However, in various implementations, the operations may be reordered and/or repeated as may be suitable. In some examples, different operations may be performed in parallel, as may be appropriate.

The term computer-readable medium does not encompass transitory electrical or electromagnetic signals or electromagnetic signals propagating through a medium—such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It should thus be noted that the matter contained in the above description or shown in the accompanying drawings is to be interpreted as illustrative and not in a limiting sense.

What is claimed is:

1. An identity server comprising:
a memory,
a communication interface configured to communicate with a partner device, a first transaction communication network, and a second transaction communication network that is separate and distinct from the first transaction communication network, and
an electronic processor that is configured to
perform an identity affirmation of an individual by communicating with a first entity over the first transaction communication network and communicating with a second entity over the second transaction communication network, and
control the communication interface to output an identity affirmation message to the partner device based on the identity affirmation that is performed.

2. The identity server of claim 1, wherein, to perform the identity affirmation of the individual, the electronic processor is configured to:
control the communication interface to receive payment account information of the individual,
responsive to receiving the payment account information of the individual, control the communication interface to send an identity test of a first account at the first entity via the first transaction communication network, the identity test based at least in part on the payment account information of the individual,
control the communication interface receive first data insights, first risk scores, and account information regarding the first account based on the identity test that is sent,
responsive to receiving the payment account information of the individual, control the communication interface to query the second transaction communication network for account identity metadata of a second account at the second entity, the query based on the payment account information of the individual,
control the communication interface to receive second data insights, second risk scores, account details, and identity data regarding the second account from the second transaction communication network, and
determine whether the payment account information is owned by the individual based on the first data insights, the first risk scores, and the account information regarding the first account in addition to the second data insights, the second risk scores, the account details, and the identity data regarding the second account.

3. The identity server of claim 2, wherein the payment account information includes some or all of identity data, device data, debit card credentials, and user account information.

4. The identity server of claim 2, wherein the identity test is a test deposit to the first account.

5. The identity server of claim 2, wherein the account identity information includes some or all of name, address, phone number, email address, transaction history of the second account.

6. The identity server of claim 2, wherein, to output the identity affirmation message to the partner device based on the identity affirmation that is performed, the electronic processor is further configured to responsive to determining that the payment account information is owned by the individual, control the communication interface to output a deposit approval control signal to the partner device.

7. The identity server of claim 2, wherein, to output the identity affirmation message to the partner device based on the identity affirmation that is performed, the electronic processor is further configured to responsive to determining that the payment account information is not owned by the individual, control the communication interface to output a deposit disapproval control signal to the partner device.

8. A method comprising:
performing, with an electronic processor, an identity affirmation of an individual by communicating with a first entity over a first transaction communication network and communicating with a second entity over a second transaction communication network that is separate and distinct from the first transaction communication network; and
outputting, with the electronic processor, an identity affirmation message to a partner device based on the identity affirmation that is performed.

9. The method of claim 8, wherein performing the identity affirmation of the individual includes
receiving payment account information of the individual,
sending an identity test of a first account at the first entity via the first transaction communication network, the identity test based at least in part on the payment account information of the individual,
receiving first data insights, first risk scores, and account information regarding the first account based on the identity test that is sent,
querying the second transaction communication network for account identity metadata of a second account at the second entity, the query based on the payment account information of the individual,
receiving second data insights, second risk scores, account details, and identity data regarding the second account from the second transaction communication network, and
determining whether the payment account information is owned by the individual based on the first data insights, the first risk scores, and the account information regarding the first account in addition to the second data insights, the second risk scores, the account details, and the identity data regarding the second account.

10. The method of claim 9, wherein the payment account information includes some or all of identity data, device data, debit card credentials, and user account information.

11. The method of claim 9, wherein the identity test is a test deposit to the first account.

12. The method of claim 9, wherein the account identity information includes some or all of name, address, phone number, email address, transaction history of the second account.

13. The method of claim 9, wherein outputting the identity affirmation message to the partner device based on the identity affirmation that is performed further includes outputting a deposit approval control signal to the partner device in response to determining that the payment account information is owned by the individual.

14. The method of claim 9, wherein outputting the identity affirmation message to the partner device based on the identity affirmation that is performed further includes outputting a deposit disapproval control signal to the partner device in response to determining that the payment account information is not owned by the individual.

15. A non-transitory computer-readable medium comprising instructions that, when executed by an electronic processor, causes the electronic processor to perform a set of operations comprising:
performing an identity affirmation of an individual by communicating with a first entity over a first transaction communication network and communicating with a second entity over a second transaction communication network that is separate and distinct from the first transaction communication network; and
controlling a communication interface to output an identity affirmation message to a partner device based on the identity affirmation that is performed.

16. The non-transitory computer-readable medium of claim 15, wherein performing the identity affirmation includes
controlling the communication interface to receive payment account information of the individual;
controlling the communication interface to send an identity test of a first account at the first entity via the first transaction communication network, the identity test based at least in part on the payment account information of the individual;
controlling the communication interface to receive first data insights, first risk scores, and account information regarding the first account based on the identity test that is sent;
controlling the communication interface to query the second transaction communication network for account identity metadata of a second account at the second entity, the query based on the payment account information of the individual;
controlling the communication interface to receive second data insights, second risk scores, account details, and identity data regarding the second account from the second transaction communication network; and
determining whether the payment account information is owned by the individual based on the first data insights, the first risk scores, and the account information regarding the first account in addition to the second data insights, the second risk scores, the account details, and the identity data regarding the second account.

17. The non-transitory computer-readable medium of claim 16, wherein the payment account information includes some or all of identity data, device data, debit card credentials, and user account information.

18. The non-transitory computer-readable medium of claim 16, wherein the account identity information includes some or all of name, address, phone number, email address, transaction history of the second account.

19. The non-transitory computer-readable medium of claim 16, wherein controlling the communication interface to output the identity affirmation message to the partner device based on the identity affirmation that is performed further includes controlling the communication interface to output a deposit approval control signal to the partner device in response to determining that the payment account information is owned by the individual.

20. The non-transitory computer-readable medium of claim 16, wherein controlling the communication interface to output the identity affirmation message to the partner device based on the identity affirmation that is performed further includes controlling the communication interface to output a deposit disapproval control signal to the partner device in response to determining that the payment account information is not owned by the individual.
